(19) United States
(12) Patent Application Publication
(10) Pub. No.: US 2022/0107010 A1
(43) Pub. Date: Apr. 7, 2022

(54) BALL SCREW DEVICE

(71) Applicant: JTEKT CORPORATION, Kariya-shi (JP)

(72) Inventors: Akiyoshi TASHIRO, Yamatotakada-shi (JP); Ikuo YAMAMOTO, Kashiwara-shi (JP)

(73) Assignee: JTEKT CORPORATION, Kariya-shi (JP)

(21) Appl. No.: 17/492,014

(22) Filed: Oct. 1, 2021

(30) Foreign Application Priority Data
Oct. 6, 2020 (JP) 2020-169074

(51) Int. Cl. F16H 25/22

(52) U.S. Cl. CPC F16H 25/2219

(57) ABSTRACT

A ball screw device includes a threaded shaft, a nut, and balls. The nut body includes a central tubular portion and an end tubular portion. The central tubular portion has a through-hole and an end surface. The nut further includes a circulation member and a snap ring. The circulation member is provided on an inner peripheral side of the end tubular portion such that the circulation member is in contact with the end surface. The snap ring is fitted to a circumferential groove provided on an inner periphery of the end tubular portion. The snap ring is configured to fix the circulation member in a manner such that the circulation member is sandwiched between the snap ring and the end surface.

### CROSS-REFERENCE TO RELATED APPLICATION

This application claims priority to Japanese Patent Application No. 2020-169074 filed on Oct. 6, 2020, incorporated herein by reference in its entirety.

### BACKGROUND

### 1. Technical Field

The disclosure relates to a ball screw device.

### 2. Description of Related Art

Japanese Unexamined Patent Application Publication No. 2016-35286 (JP 2016-35286 A) describes a ball screw device including a threaded shaft having a first spiral groove formed on an outer periphery of the threaded shaft, a nut having a second spiral groove formed on an inner periphery of the nut, and a plurality of balls disposed on a rolling raceway formed between the first spiral groove and the second spiral groove. The nut includes a nut body having a cylindrical shape, and circulation members attached to the opposite sides of the nut body in its axial direction. The nut body has a through-hole formed to extend through the nut body in the axial direction. A passage is formed on each of the circulation members from its side face to its inner peripheral surface. The through-hole and the passages constitute a circulation passage that allows the balls to circulate from a first end part of the rolling raceway to a second end part of the rolling raceway.

### SUMMARY

In the ball screw device in the related art, the circulation member is attached to the nut body by tightening bolts to bolt holes formed in the nut body. The second spiral groove is formed in the nut body, and the balls make rolling contact with the second spiral groove. Accordingly, a heat treatment, i.e., carburizing-quenching and tempering, is performed on the nut body. For this purpose, before the heat treatment is performed, an anti-cementation agent (an anti-carburization agent) is applied to the bolt holes, and after the heat treatment, an operation to remove the anti-cementation agent (anti-carburization agent) is performed.

Thus, the ball screw device in the related art requires an additional operation for the heat treatment, and this causes an increase in cost. Further, at the time when the circulation member is attached to the nut body, it is necessary to tighten the bolts to four parts of the nut body, for example, and many man-hours for assembly are required. For those reasons, a manufacturing cost for the ball screw device is increased.

In view of this, this disclosure provides a ball screw device that can be easily assembled and can achieve a cost reduction.

A ball screw device according to one aspect of this disclosure includes a threaded shaft, a nut, and a plurality of balls. The threaded shaft has a first spiral groove provided on an outer periphery of the threaded shaft. The nut includes a nut body having a second spiral groove provided on an inner periphery of the nut body. The balls are disposed on a rolling raceway provided between the first spiral groove and the second spiral groove. The nut body includes a central tubular portion and an end tubular portion. The central tubular portion has a tubular shape. The central tubular portion has a through-hole extending axially and an end surface facing axially. The balls are passed through the through-hole, and the through-hole is opened on the end surface. The end tubular portion has a tubular shape. The end tubular portion is provided to surround the end surface from an outer peripheral side of the end surface and to extend axially from the central tubular portion. The nut further includes a circulation member and a snap ring. The circulation member is provided on an inner peripheral side of the end tubular portion such that the circulation member is in contact with the end surface. The circulation member includes a passage via which the through-hole is connected to the rolling raceway. The snap ring is fitted to a circumferential groove provided on an inner periphery of the end tubular portion. The snap ring is configured to fix the circulation member in a manner such that the circulation member is sandwiched between the snap ring and the end surface.

In the ball screw device having this configuration, the circulation member is provided on the inner peripheral side of the end tubular portion of the nut body such that the circular member is in contact with the end surface of the central tubular portion. When the snap ring is fitted to the circumferential groove provided on the inner periphery of the end tubular portion, the circulation member is attached to the nut body. Accordingly, unlike the related art, bolts for attaching the circulation member to the nut body are not necessary, and holes (tap holes) for the bolts do not need to be provided in the nut body. Thus, it is possible to provide a ball screw device that can be easily assembled and can achieve a cost reduction.

Further, the circulation member may be constituted by a plurality of resin molded components into which the circulation member is axially dividable. In the configuration, the passage has a complicated shape, but the circulation member can be molded by injection molding. This contributes to a cost reduction. Since the circulation member has a structure that is axially dividable, it is possible to facilitate removal from a mold for injection molding.

Further, the snap ring may be a bevel-shaped snap ring. In the above configuration, a difference in deformation dimension due to temperature changes between the nut body and the circulation member and an influence of manufacture dimension error are absorbed. Further, the circulation member is fixed to the nut body stably.

Further, an axial end surface of the end tubular portion may serve as a load transmission surface via which an axial thrust of the nut is transmitted to a to-be-moved member. With the configuration, the size of the nut in its radial direction can be reduced, so that a compact ball screw device can be provided.

According to the aspect of this disclosure, it is possible to easily assemble a ball screw device and to achieve a cost reduction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a ball screw device;

FIG. 2 is a sectional view of a ball screw device illustrated in FIG. 1;

FIG. 3 is a perspective view of a circulation member;

FIG. 4 is an exploded perspective view of the circulation member illustrated in FIG. 3; and

FIG. 5 is an enlarged sectional view illustrating a first snap ring in a state where the first snap ring is fitted to a first circumferential groove, and a peripheral area around the first snap ring.

### DETAILED DESCRIPTION OF EMBODIMENTS

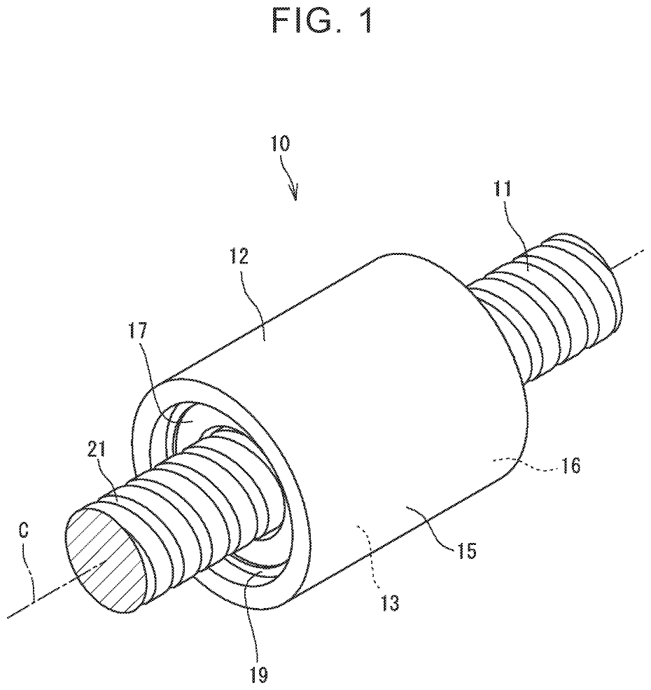

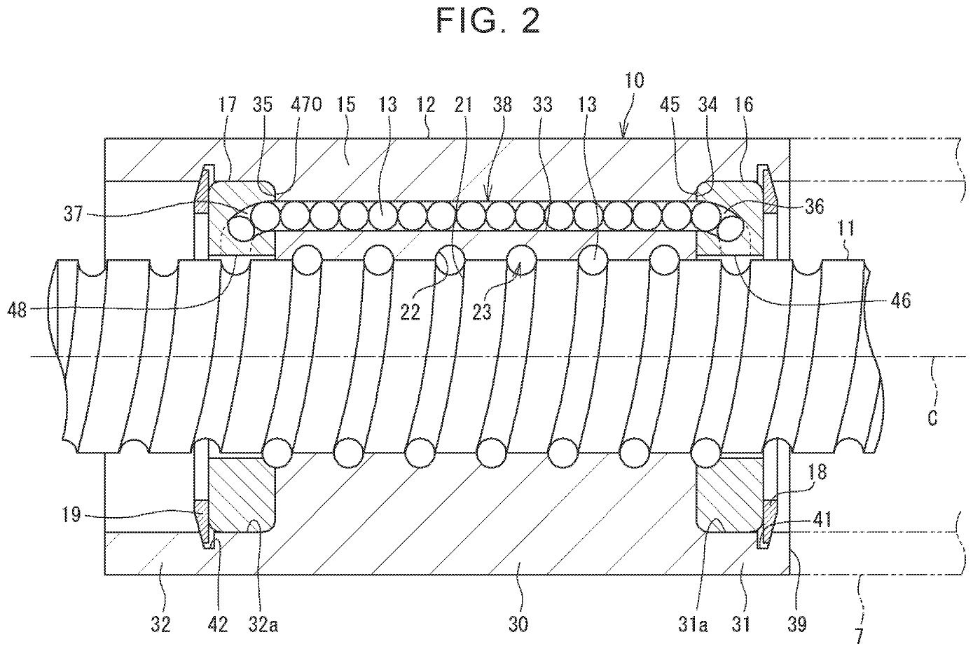

The overall configuration of a ball screw device will be described. FIG. 1 is a perspective view of a ball screw device. FIG. 2 is a sectional view of the ball screw device illustrated in FIG. 1. The ball screw device 10 of the present embodiment includes a threaded shaft 11, a nut 12 having a cylindrical shape, and a plurality of balls 13. The nut 12 includes a nut body 15, and two circulation members 16, 17 (a first circulation member 16 and a second circulation member 17) attached to the opposite sides of the nut body 15 in its axial direction. A center line C of the threaded shaft 11 coincides with the center line of the nut 12. The center line C is also the center line of the ball screw device 10.

The threaded shaft 11 is connected to a driving device such as a motor (not illustrated) such that the threaded shaft 11 is rotationally driven around the center line C of the threaded shaft 11 by the driving device. When the threaded shaft 11 rotates in a first direction (a normal rotation), the nut 12 moves to a first side in the axial direction, and when the threaded shaft 11 rotates in a second direction (a reverse rotation), the nut 12 moves to a second side in the axial direction.

In this disclosure, a direction along the center line C is defined as the “axial direction.” The axial direction also includes a direction parallel to the center line C. A direction perpendicular to the center line C is referred to as a “radial direction,” and a direction along a circle around the center line C is defined as a “circumferential direction.”

The ball screw device 10 of the present embodiment is applied to a braking device for a vehicle (e.g., an automobile), particularly, an electric booster, for example. Although not illustrated herein, an output shaft of the driving device (an output shaft of a motor) is connected to the second side (the left side in FIG. 2) of the threaded shaft 11 in the axial direction, for example. A member (hereinafter referred to as a “to-be-moved member 7”) connected to a piston included in the braking device is provided on the first side with respect to the nut 12 (i.e., on the right side of the nut 12 in FIG. 2) in the axial direction. In the present embodiment, the to-be-moved member 7 includes a cylindrical portion having the same outside diameter as that of the nut 12 such that the cylindrical portion is provided at the second side of the to-be-moved member 7 in the axial direction. By the rotation of the threaded shaft 11, the nut 12 moves to the first side in the axial direction so as to press the to-be-moved member 7 to the first side in the axial direction. Thus, a braking force is generated. Note that the ball screw device 10 of this disclosure is also applicable to a device other than the braking device.

The threaded shaft 11 is a member having a columnar shape. The threaded shaft 11 has a first spiral groove 21 as a single-thread screw, and the first spiral groove 21 is formed on an outer periphery of the threaded shaft 11. The nut 12 includes the nut body 15 and the two circulation members 16, 17 as described above (see FIG. 2). The nut body 15 has a cylindrical shape, and a second spiral groove 22 is formed on an inner periphery of the nut body 15. The second spiral groove 22 is formed to have the same pitch and the same number of threads as those of the first spiral groove 21. The first spiral groove 21 and the second spiral groove 22 can be formed to face each other, and a rolling raceway 23 as a spiral passage is formed between the first spiral groove 21 and the second spiral groove 22.

A plurality of balls 13 is disposed on the rolling raceway 23. When the threaded shaft 11 rotates, the balls 13 move on the rolling raceway 23 in a rolling manner. Since a load is applied to the first spiral groove 21 and the second spiral groove 22 from the balls 13, the nut body 15 and the threaded shaft 11 are heat-treated components subjected to a heat treatment so as to obtain hardness. More specifically, quenching (carburizing-quenching) and tempering are performed on the nut body 15 and the threaded shaft 11. Note that a plurality of threads may be formed on the first spiral groove 21 and the second spiral groove 22.

The nut body 15 includes a central tubular portion 30 having a tubular shape, a first-end tubular portion 31 having a tubular shape, and a second-end tubular portion 32 having a tubular shape. The central tubular portion 30, the first-end tubular portion 31, and the second-end tubular portion 32 are constituted by a single tubular block made of steel. That is, a central part of the single tubular block is the central tubular portion 30, and the opposite parts of the single tubular block are the first-end tubular portion 31 and the second-end tubular portion 32. The first-end tubular portion 31 and the second-end tubular portion 32 have the same outside diameter as that of the central tubular portion 30 but have an inside diameter larger than that of the central tubular portion 30.

A second spiral groove 22 is formed on an inner peripheral surface of the central tubular portion 30. Further, the central tubular portion 30 has a through-hole 33 elongated in the axial direction and formed such that the balls 13 are passed through the through-hole 33. The central tubular portion 30 has a first end surface 34 facing the first side in the axial direction and a second end surface 35 facing the second side in the axial direction. The first end surface 34 and the second end surface 35 are annular surfaces facing the axial direction (i.e., facing axially) and are surfaces along a virtual plane perpendicular to the center line C. The first side of the through-hole 33 in the axial direction is opened on the first end surface 34, and the second side of the through-hole 33 in the axial direction is opened on the second end surface 35.

The first-end tubular portion 31 is provided to surround the first end surface 34 from the outer peripheral side of the first end surface 34 and to extend to the first side in the axial direction from an outer peripheral part of the central tubular portion 30. The second-end tubular portion 32 is provided to surround the second end surface 35 from the outer peripheral side and to extend to the second side in the axial direction from the outer peripheral part of the central tubular portion 30. With this configuration, the nut body 15 has a shape with a stepped hole on each of opposite sides in the axial direction. An inner peripheral surface 31a of the first-end tubular portion 31 is a cylindrical surface, and a first circumferential groove 41 is formed on a part of the inner peripheral surface 31a. An inner peripheral surface 32a of the second-end tubular portion 32 is a cylindrical surface, and a second circumferential groove 42 is formed on a part of the inner peripheral surface 32a. The inner peripheral surfaces 31a, 32a are cylindrical surfaces around the center line C.

As described above, when the threaded shaft 11 rotates in the normal direction and the nut 12 moves to the first side in the axial direction, the nut 12 presses the to-be-moved member 7 to the first side in the axial direction. That is, an end surface 39 (an axial end surface 39) at the first side of the first-end tubular portion 31 in the axial direction makes contact with the to-be-moved member 7 from the axial direction and further presses the to-be-moved member 7 to the first side in the axial direction. Thus, a braking force is generated by the braking device. In the present embodiment, the end surface 39 at the first side of the first-end tubular portion 31 in the axial direction serves as a load transmission surface via which a thrust of the nut 12 to the first side in the axial direction is transmitted to the to-be-moved member 7.

When the threaded shaft 11 rotates in the reverse direction and the nut 12 moves to the second side in the axial direction from the state where the braking force is generated in the braking device, the thrust of the nut 12 to the to-be-moved member 7 is stopped. Thus, the braking force generated by the braking device is stopped. The to-be-moved member 7 may be configured to follow the nut 12 to the first side and to the second side in the axial direction. For example, the end surface 39 at the first side of the first-end tubular portion 31 in the axial direction may serve as a load transmission surface that contacts the to-be-moved member 7 in the axial direction, and an end part at the first side of the first-end tubular portion 31 in the axial direction may serve as a fitting portion fitted to an end part of the to-be-moved member 7 in a close contact manner although not illustrated herein. In this case, the nut 12 is integrated with the to-be-moved member 7.

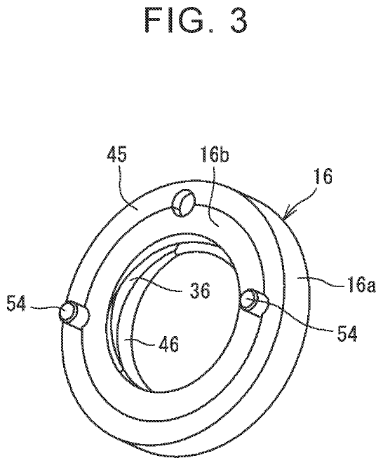

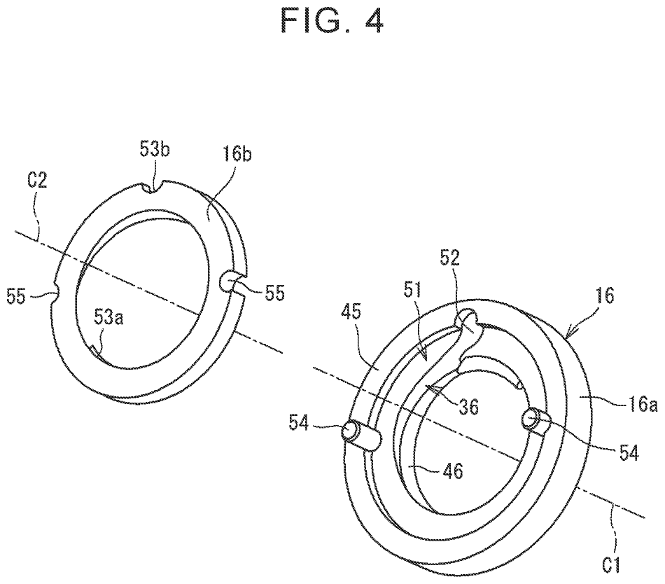

FIG. 3 is a perspective view of the first circulation member 16. FIG. 4 is an exploded perspective view of the first circulation member 16 illustrated in FIG. 3. The first circulation member 16 is made of resin, and in the present embodiment, the first circulation member 16 is constituted by two resin molded components 16a, 16b into which the first circulation member 16 is dividable in the axial direction. Note that the number of division of the first circulation member 16 (i.e., the number of components constituting the first circulation member 16) may be any number other than two, and the first circulation member 16 may be divided into three or more. The first circulation member 16 of the present embodiment is an annular member.

A first passage 36 is formed in the first circulation member 16 provided at the first side of the nut 12 in the axial direction (see FIG. 2). The first passage 36 is constituted by a groove and a hole formed in an area from a side face 45 at the second side of the first circulation member 16 in the axial direction to an inner peripheral surface 46. A second passage 37 is formed in the second circulation member 17 provided at the second side of the nut 12 in the axial direction. The second passage 37 is constituted by a groove and a hole formed in an area from a side face 470 at the first side of the second circulation member 17 in the axial direction to an inner peripheral surface 48. The first circulation member 16 and the second circulation member 17 have the same configuration and are attached to the nut body 15 such that they face toward the opposite sides in the axial direction.

A circulation passage 38 of the nut 12 is constituted by the first passage 36, the through-hole 33 of the central tubular portion 30, and the second passage 37. The balls 13 are disposed on the circulation passage 38.

When the threaded shaft 11 rotates, the balls 13 on the rolling raceway 23 roll on the rolling raceway 23 (the first spiral groove 21 and the second spiral groove 22) and apply an axial force to the nut 12, and thus, the nut 12 moves in the axial direction. The balls 13 pass through the circulation passage 38 from a first end of the rolling raceway 23, and depending on a movement stroke of the nut 12, the balls 13 can return to a second end of the rolling raceway 23. That is, the balls 13 can circulate through the rolling raceway 23 and the circulation passage 38.

As described above, the first circulation member 16 is provided at the first side of the nut 12 in the axial direction, and the first circulation member 16 includes the first passage 36 via which the through-hole 33 is connected to the rolling raceway 23 (the second spiral groove 22 constituting the rolling raceway 23). The first passage 36 has a function to move the balls 13 that have passed through the rolling raceway 23 to the through-hole 33 when the threaded shaft 11 rotates, and the first passage 36 also has a function to return the balls 13 that have passed through the through-hole 33 to the rolling raceway 23 when the threaded shaft 11 rotates in the opposite direction to the above.

The second circulation member 17 is provided at the second side of the nut 12 in the axial direction, and the second circulation member 17 includes the second passage 37 via which the through-hole 33 is connected to the rolling raceway 23 (the second spiral groove 22 constituting the rolling raceway 23). The second passage 37 has a function to return the balls 13 that have passed through the through-hole 33 to the rolling raceway 23 when the threaded shaft 11 rotates, and the second passage 37 also has a function to move the balls 13 that have passed through the rolling raceway 23 to the through-hole 33 when the threaded shaft 11 rotates in the opposite direction to the above.

As illustrated in FIG. 2, the first circulation member 16 is provided on the inner peripheral side of the first-end tubular portion 31 so as to be in contact with the first end surface 34. The ball screw device 10 further includes a first snap ring 18 fitted to the first circumferential groove 41 formed on the inner periphery of the first-end tubular portion 31. The first snap ring 18 positions and fixes the first circulation member 16 in a manner such that the first circulation member 16 is sandwiched between the first snap ring 18 and the first end surface 34.

The second circulation member 17 is provided on the inner peripheral side of the second-end tubular portion 32 so as to be in contact with the second end surface 35. The ball screw device 10 further includes a second snap ring 19 fitted to the second circumferential groove 42 formed on the inner periphery of the second-end tubular portion 32. The second snap ring 19 positions and fixes the second circulation member 17 in a manner such that the second circulation member 17 is sandwiched between the second snap ring 19 and the second end surface 35.

The first snap ring 18 for fixation of the first circulation member 16 and the second snap ring 19 for fixation of the second circulation member 17 have the same configuration (i.e., each of the first snap ring 18 and the second snap ring 19 is a C-shaped snap ring). As described above, the first circulation member 16 and the second circulation member 17 are fixed to the nut body 15 by the first snap ring 18 and the second snap ring 19, respectively. Accordingly, in the ball screw device 10 of the present embodiment, bolts for attaching the circulation members are not necessary, and holes (tap holes) for the bolts do not need to be provided, unlike the related art.

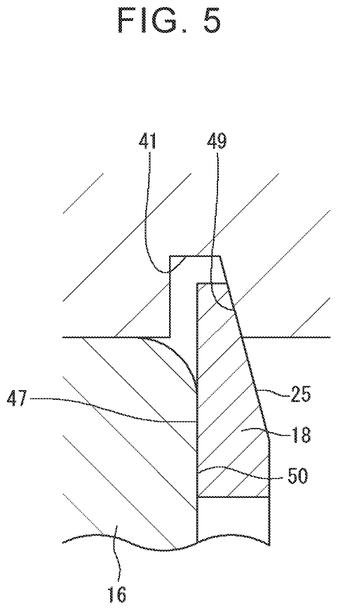

FIG. 5 is an enlarged sectional view illustrating the first snap ring 18 in a state where the first snap ring 18 is fitted to the first circumferential groove 41, and a peripheral area around the first snap ring 18. The first snap ring 18 is a bevel-shaped snap ring. That is, the first snap ring 18 has a tapered surface 25 formed on an outer peripheral side of one side face of the first snap ring 18 such that the tapered surface 25 gradually reduces the thickness of the first snap ring 18 toward its radially outer side. Another side face 47 of the first snap ring 18 is a contact face that is in contact with a side face 50 of the first circulation member 16. Each of the side face 47 and the side face 50 has a shape along a plane perpendicular to the center line C.

The first circumferential groove 41 has a tapered surface 49 making surface contact with the tapered surface 25 of the first snap ring 18. Due to the bevel-shaped first snap ring 18 and the first circumferential groove 41, the first circulation member 16 is pressed against the first end surface 34 (see FIG. 2) of the central tubular portion 30 in the axial direction.

The second snap ring 19 at the second side in the axial direction is also a bevel-shaped snap ring, and the second circumferential groove 42 has a tapered surface similarly to the first circumferential groove 41. Similarly to the first side in the axial direction, due to the second snap ring 19 and the second circumferential groove 42, the second circulation member 17 is pressed against the second end surface 35 of the central tubular portion 30 in the axial direction.

The circulation members 16, 17 will be described. With reference to FIGS. 3, 4, the following describes the first circulation member 16. As described above, the circulation member 16 is made of resin, and the circulation member 16 is constituted by two resin molded components 16a, 16b (a first resin molded component 16a and a second resin molded component 16b) into which the circulation member 16 is dividable in the axial direction (i.e., into which the circulation member 16 is axially divided). When the second resin molded component 16b is fitted into a recessed portion 51 formed in a side part of the first resin molded component 16a, the resin molded components 16a, 16b are combined with each other, and thus, one circulation member 16 is formed. A center line C1 of the first resin molded component 16a coincides with a center line C2 of the second resin molded component 16b. The two resin molded components 16a, 16b are manufactured by injection molding. When molds are formed, many resin molded components 16a, 16b can be easily manufactured.

Surfaces of each of the resin molded components 16a, 16b are formed such that each of the resin molded components 16a, 16b can be removed from a forming mold by dividing the forming mold in the axial direction. That is, the first resin molded component 16a has a groove 52 by which the first passage 36 is formed, in addition to the recessed portion 51 into which the second resin molded component 16b is fitted. Each of surfaces constituting the recessed portion 51 and the groove 52 is a surface parallel to the center line C1 of the first resin molded component 16a or a surface observable when the first resin molded component 16a is viewed in the axial direction. Similarly, the second resin molded component 16b has grooves 53a, 53b by which the first passage 36 is formed. Each of surfaces constituting the grooves 53a, 53b is a surface parallel to the center line C2 of the second resin molded component 16b or a surface observable when the second resin molded component 16b is viewed in the axial direction (i.e., when the second resin molded component 16b is viewed from the side opposite to the side from which the first resin molded component 16a is viewed). Since each of the resin molded components 16a, 16b is formed in the above-mentioned manner, each of the resin molded components 16a, 16b is not forcibly removed from the forming mold when the forming mold is divided (separated) in the axial direction.

Recessed portions and projection portions fitted to each other are provided in the first resin molded component 16a and the second resin molded component 16b so that the first resin molded component 16a and the second resin molded component 16b are combined with each other by being positioned with respect to each other in the circumferential direction. In the present embodiment, projection portions 54 are provided in the first resin molded component 16a, and cut portions 55 to which the projection portions 54 are fitted are formed in the second resin molded component 16b. When the projection portions 54 are fitted to the cut portions 55, the first resin molded component 16a and the second resin molded component 16b are positioned in the circumferential direction.

Further, the projection portions 54 in the first resin molded component 16a can be fitted to holes (not illustrated) provided on the first end surface 34 of the central tubular portion 30 included in the nut body 15 (see FIG. 2). Thus, the circulation member 16 obtained by combining the first resin molded component 16a with the second resin molded component 16b can be positioned in the circumferential direction and attached to the nut body 15. As a result, such a configuration that the through-hole 33 of the central tubular portion 30 communicates with the first passage 36 of the circulation member 16 can be provided.

Note that the second circulation member 17 provided at the second side in the axial direction is also formed similarly to the first circulation member 16.

The ball screw device 10 of the present embodiment will be described. As described above, the ball screw device 10 of the present embodiment includes the threaded shaft 11 having the first spiral groove 21 formed on the outer periphery of the threaded shaft 11, the nut 12 including the nut body 15 having the second spiral groove 22 formed on the inner periphery of the nut body 15, and the balls 13. The balls 13 are disposed on the rolling raceway 23 formed between the first spiral groove 21 and the second spiral groove 22.

The nut body 15 includes the central tubular portion 30 having a tubular shape, the first-end tubular portion 31 having a tubular shape and provided at the first side in the axial direction, and the second-end tubular portion 32 having a tubular shape and provided at the second side in the axial direction. The central tubular portion 30 has the through-hole 33 formed in the axial direction such that the balls 13 are passed through the through-hole 33, and the central tubular portion 30 also has the first end surface 34 facing the first side in the axial direction and formed such that the through-hole 33 is opened on the first end surface 34. The central tubular portion 30 further has the second end surface 35 facing the second side in the axial direction and formed such that the through-hole 33 is opened on the second end surface 35. The first-end tubular portion 31 is provided to surround the first end surface 34 from the outer peripheral side of the first end surface 34 and to extend to the first side in the axial direction from the central tubular portion 30. The second-end tubular portion 32 is provided to surround the second end surface 35 from the outer peripheral side of the second end surface 35 and to extend to the second side in the axial direction from the central tubular portion 30.

The nut 12 includes the first circulation member 16 and the first snap ring 18 that are provided at the first side in the axial direction, in addition to the nut body 15. The first circulation member 16 and the first snap ring 18 are formed separately from the nut body 15. The first circulation member 16 is provided on the inner peripheral side of the first-end tubular portion 31 so as to be in contact with the first end surface 34. The first circulation member 16 includes the first passage 36 via which the through-hole 33 is connected to the rolling raceway 23. The first snap ring 18 is fitted to the first circumferential groove 41 formed on the inner periphery of the first-end tubular portion 31 and fixes the first circulation member 16 in a manner such that the first circulation member 16 is sandwiched between the first snap ring 18 and the first end surface 34.

The nut 12 further includes the second circulation member 17 and the second snap ring 19 that are provided at the second side in the axial direction. The second circulation member 17 and the second snap ring 19 are formed separately from the nut body 15. The second circulation member 17 is provided on the inner peripheral side of the second-end tubular portion 32 so as to be in contact with the second end surface 35. The second circulation member 17 includes the second passage 37 via which the through-hole 33 is connected to the rolling raceway 23. The second snap ring 19 is fitted to the second circumferential groove 42 formed on the inner periphery of the second-end tubular portion 32 and fixes the second circulation member 17 in a manner such that the second circulation member 17 is sandwiched between the second snap ring 19 and the second end surface 35.

In the ball screw device 10 having this configuration, the first circulation member 16 is provided on the inner peripheral side of the first-end tubular portion 31 of the nut body 15 so as to be in contact with the first end surface 34 of the central tubular portion 30. When the first snap ring 18 is fitted to the first circumferential groove 41, the first circulation member 16 is attached to the nut body 15. Similarly to this, the second circulation member 17 is provided on the inner peripheral side of the second-end tubular portion 32 of the nut body 15 so as to be in contact with the second end surface 35 of the central tubular portion 30. When the second snap ring 19 is fitted to the second circumferential groove 42, the second circulation member 17 is attached to the nut body 15.

Accordingly, unlike the related art, bolts for attaching the circulation members to the nut body are not necessary, and holes (tap holes) for the bolts do not need to be provided in the nut body 15. As a result, even in a case where the nut body 15 is subjected to a heat treatment, an operation to apply an anti-cementation agent (anti-carburization agent) and an operation to remove the anti-cementation agent (anti-carburization agent) are unnecessary, unlike the related art. Accordingly, the ball screw device 10 of the present embodiment can be easily assembled and achieve a cost reduction.

In the present embodiment (see FIGS. 3, 4), the first circulation member 16 (the second circulation member 17) is constituted by two resin molded components into which the first circulation member 16 (the second circulation member 17) is dividable in the axial direction. Accordingly, the first passage 36 (the second passage 37) of the first circulation member 16 (the second circulation member 17) has a complicated shape, but the first circulation member 16 (the second circulation member 17) can be molded by injection molding, and this contributes to a cost reduction. Further, the first circulation member 16 (the second circulation member 17) has a structure dividable in the axial direction as described above, thereby making it possible to facilitate removal from the molds for injection molding.

In the ball screw device 10 of the present embodiment, the circulation members 16, 17 made of resin are attached to the nut body 15 made of steel. Since there is a difference between the materials (that is, a difference in linear expansion coefficient), the nut body 15 and the circulation members 16, 17 have different thermal expansion amounts and thermal contraction amounts associated with temperature changes. However, in the present embodiment, the snap rings 18, 19 are bevel-shaped snap rings. In this configuration, a difference in deformation dimension due to temperature changes between the nut body 15 and the circulation members 16, 17 and an influence of manufacture dimension error are absorbed. Further, since the circulation members 16, 17 are pressed in the axial direction by the bevel-shaped snap rings 18, 19, the circulation members 16, 17 are fixed to the nut body 15 stably.

In the present embodiment, as described above, the end surface 39 at the first side, in the axial direction, of the first-end tubular portion 31 included in the nut body 15 serves as a load transmission surface via which an axial thrust of the nut 12 is transmitted to the to-be-moved member 7. Therefore, in the nut body 15, it is not necessary to provide a flange portion that is connected to the to-be-moved member to apply a thrust to the to-be-moved member, for example. Such a flange portion is provided to extend radially outwardly from the nut body 15. Accordingly, in the present embodiment, the size of the nut 12 particularly in the radial direction can be reduced, and thus, the ball screw device 10 with a compact size can be obtained.

In the present embodiment, each of the first circulation member 16 and the second circulation member 17 is an annular member but may not have an annular shape. For example, each of the first circulation member 16 and the second circulation member 17 may have an arcuate shape (an arc shape) or may be a block that is provided to extend along the circumferential direction, and is short in the circumferential direction.

The embodiment described herein is just an example in all respects and is not limitative. That is, the ball screw device of the disclosure is not limited to the embodiment illustrated in the drawings and may have other embodiments within the scope of the disclosure.

What is claimed is:

1. A ball screw device comprising:
a threaded shaft having a first spiral groove provided on an outer periphery of the threaded shaft;
a nut including a nut body having a second spiral groove provided on an inner periphery of the nut body; and
a plurality of balls disposed on a rolling raceway provided between the first spiral groove and the second spiral groove, wherein:
the nut body includes
a central tubular portion having a tubular shape, the central tubular portion having a through-hole extending axially and an end surface facing axially, the balls being passed through the through-hole, and the through-hole being opened on the end surface, and
an end tubular portion having a tubular shape, the end tubular portion being provided to surround the end surface from an outer peripheral side of the end surface and to extend axially from the central tubular portion; and
the nut further includes
a circulation member provided on an inner peripheral side of the end tubular portion such that the circulation member is in contact with the end surface, the circulation member including a passage via which the through-hole is connected to the rolling raceway, and
a snap ring fitted to a circumferential groove provided on an inner periphery of the end tubular portion, the snap ring being configured to fix the circulation member in a manner such that the circulation member is sandwiched between the snap ring and the end surface.

2. The ball screw device according to claim 1, wherein the circulation member is constituted by a plurality of resin molded components into which the circulation member is axially dividable.

3. The ball screw device according to claim 1, wherein the snap ring is a bevel-shaped snap ring.

4. The ball screw device according to claim 1, wherein an axial end surface of the end tubular portion serves as a load transmission surface via which an axial thrust of the nut is transmitted to a to-be-moved member.
